(19) United States
(12) Patent Application Publication
(10) Pub. No.: US 2009/0091522 A1
(43) Pub. Date: Apr. 9, 2009

(54) DRIVING AN IN-PLANE PASSIVE MATRIX DISPLAY

(75) Inventors: Mark Thomas Johnson, Eindhoven (NL); Franciscus Paulus Maria Budzelaar, Eindhoven (NL); Alwin Rogier Martijn Verschueren, Eindhoven (NL); Martinus Hermanus Wilhelmus Maria Van Delden, Eindhoven (NL); Sander Jurgen Roosendaal, Eindhoven (NL); Murray Fulton Gillies, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/282,182

(22) PCT Filed: Mar. 6, 2007
(86) PCT No.: PCT/IB2007/050740

§ 371 Date: Sep. 9, 2008

(30) Foreign Application Priority Data
Mar. 14, 2006 (EP) 06111090.4

(51) Int. Cl. G09G 3/34

(52) U.S. Cl. 345/84

(57) ABSTRACT

A driving circuit for driving an in-plane moving particle device has a pixel (P) comprising movable charged particles (PA). The pixel (P) has a reservoir electrode (RE), a display electrode (DE), and a gate electrode (GE) laterally placed in-between the reservoir electrode (RE) and the display electrode (DE). The driving circuit (DC) comprises a driver (DR), a controller (CO) which receives an input signal (OS) representing an image to be displayed on the moving particle device. The controller (CO) controls the driver (DR) to supply a first voltage difference (VD1) between the reservoir electrode (RE) and the gate electrode (GE) and a second voltage difference (VD2) between the gate electrode (GE) and the display electrode (DE). The image is written to the pixel (P) during a write phase (TW) by moving particles (PA) from the reservoir electrode (RE) via the gate electrode (GE) to the display electrode (DE) if the optical state of the pixel (P) should change in conformity with the image. If during the write phase (TW) the optical state of the pixel (P) should not change, the first voltage difference (VD1) has a first write level and the second voltage difference (VD2) has a second write level, both write levels are selected to repulse the particles (PA) from the gate electrode (GE). During a repulsion period (TR), the first voltage difference (VD1) has a level more repulsive to the particles than the first write level, and/or the second voltage difference (VD2) has a level more repulsive than the second write level.

The invention relates to a driving circuit for driving an in-plane passive matrix display, an in-plane passive matrix display comprising such a driving circuit, and a method of driving an in-plane passive matrix display.

In electrophoretic in-plane passive matrix displays, the pixels comprise a reservoir electrode, a gate electrode and at least one display electrode. These electrodes are arranged on a same substrate. The gate electrode is arranged in between the reservoir electrode and the display electrode. The electrophoretic material comprises charged particles which are moveable in a suspension under influence of an electrical field generated by the electrodes. The optical state of the pixels is determined by the number of particles present in a display volume associated with the display electrode. Usually, a reservoir volume associated with the reservoir electrode is shielded from the viewer.

A new image is written on the display during an image update period which comprises an erase or reset phase, a write phase, and a hold phase. During the erase phase, in all the pixels, all the particles are gathered in the reservoir volume. Consequently, all the pixels have the same starting optical state. During the write phase, usually, the pixels are selected to be written row by row. The data to be written is supplied in parallel via column electrodes to all the pixels. However, only the pixels in the selected row can change their optical state for the final image, the other pixels may be still in an “evolution” phase, but no particles cross the gate anymore. Whether a particular pixel of the selected row actually changes its optical state depends on the voltage differences between the electrodes. Once all the pixels have been selected during the write phase, all voltages can be removed from the electrodes to minimize the power consumption and the hold phase starts. Due to the bi-stable behaviour of the electrophoretic material, in the absence of any electrical field in the pixels, the pixels hold their optical state for a long period of time.

Such displays have the drawback that the optical state of the pixel may deviate from the intended optical state.

It is an object of the invention to provide a drive method for an in-plane moving particle device with an improved stability of the optical state of the pixel.

A first aspect of the invention provides a driving circuit for driving an in-plane passive matrix display as claimed in claim 1. A second aspect of the invention provides an in-plane passive matrix display as claimed in claim 16. A third aspect of the invention provides a method of driving an in-plane passive matrix display as claimed in claim 19. Advantageous embodiments are defined in the dependent claims.

A driving circuit in accordance with the first aspect of the invention drives an in-plane moving particle device with a pixel which comprises movable charged particles. The movable charged particles may be kept in a suspension. For example, the device may be an electrophoretic display. The pixel has a reservoir electrode, a display electrode, and a gate electrode laterally arranged in-between the reservoir electrode and the display electrode. Preferably, all these electrodes are directly or indirectly arranged on a same substrate such that the electrical fields created by voltages between the electrodes extend predominantly parallel with the substrate, thus in the plane of the substrate, which usually is referred to by “in-plane”. Consequently, the charged particles move between the electrodes predominantly in-plane. The moving particle device may be a passive matrix display.

The driving circuit comprises a driver and a controller. The controller receives an input signal representing an image to be displayed on the moving particle device and controls the driver to supply a first voltage difference between the reservoir electrode and the gate electrode, and a second voltage difference between the gate electrode and the display electrode. During the writing phase the image is written to the pixel by selectively moving particles from the reservoir volume via the gate volume to the display volume to obtain an optical state of the pixel in conformity with the image. The voltage differences are selected such that the particles do not move from the reservoir volume to the display volume if the optical state of the pixel should not change. The voltage differences are selected such that the particles move from the reservoir volume to the display volume if the optical state of the pixel should change. If the optical state of the pixel should not change, the first voltage difference has a first write level and said second voltage difference has a second write level, both write levels being selected to repulse the particles from the gates electrode. Consequently, the particles are unable to cross the gate electrode and thus stay in the reservoir volume associated with the reservoir electrode, and, if applicable, in the display volume associated with the display electrode. The reservoir volume, the display volume, and the gate volume associated with the gate electrode together form the pixel volume. The particles move between the volumes dependent on the voltage differences applied between the electrodes. For example, if the particles are positively charged and should be repulsed from the gate electrode, the first voltage difference between the gate electrode and the reservoir electrode should create a positive potential at the gate electrode with respect to the reservoir electrode. The same is true for the second voltage difference: the potential at the gate electrode should be positive with respect to the display electrode.

In accordance with the present invention, the controller controls the driver to supply, during a repulsion period, the first voltage difference with a level being more repulsive to the particles than the first write level, and/or the second voltage difference being more repulsive than the second write level. These extra repulsive pulses prevent the particles from crossing the gate electrode.

Although it might be expected that the particles will not cross the gate electrode due to the first and the second write levels, it appeared that this still might happen. For example if the time between two consecutive write phases is relatively long.

In an embodiment as claimed in claim 2, the moving particle device is a passive matrix display having a plurality of the pixels. The controller is constructed to control the driver to supply first voltage differences between associated gate electrodes and reservoir electrodes of the pixels, and second voltage differences between associated gate electrodes and display electrodes of the pixels. Most of the interferences are caused by the fact that the electrodes are common electrodes for several pixels. Usually, the display electrodes are interconnected at least for a group of the pixels, whilst the reservoir electrodes are interconnected at least for a group of the pixels and may indeed be common to all pixels in the display. Signals from these common electrodes can cause unwanted movement of particles in pixels which are not being written with new image information. The voltage on the gate electrode now determines whether the particles in a pixel can or cannot cross the gate electrode during the writing phase.

In an embodiment as claimed in claim 4, the drive sequence comprises a hold phase. After the write phase, the image displayed on the matrix display has been updated. Due to the bi-stable nature of the display, this image will be maintained during a relatively long period in time without the need to apply any voltages to the electrodes. This period in time that no voltages are supplied to the pixels and the written image is maintained is called the hold period.

In an embodiment as claimed in claim 5, the controller controls the driver to supply the repulsion periods during the write phase. These extra repulsion pulses minimize the effect the voltages on the common electrodes have on pixels which should not change their optical state.

In an embodiment as claimed in claim 6, the driver sequentially selects the pixels during the write phase group by group. Each group is selected during a group select period. After all the groups have been selected, all pixels have been selected and the image on the display is updated. The first voltage difference and the second voltage difference are supplied to all the pixels of a selected one of the groups during the group select period.

Usually, the pixels of the matrix display are arranged in rows and columns and the groups of pixels comprise the pixels of a row. The rows are selected one by one while the voltages are supplied to all the pixels but only should be able to change the optical state of the pixels of the actually selected row. After selecting all the rows, all the pixels have the optical state corresponding to the image to be displayed.

In an embodiment as claimed in claim 7, the controller controls the driver to supply the repulsion periods in between two successive group select periods. The repulsion periods may occur only one time or several times during the writing phase. Preferably, the repulsion periods are evenly distributed during the write phase and, preferably, have, for each group of pixels, a predetermined time offset with respect to the select period of the group. Alternatively, the repulsion pulses are applied between all group select periods during the write phase thereby optimally preventing particles from crossing the gate volume for pixels which should not change their optical state.

In an embodiment as claimed in claim 8, the controller controls the driver to supply the repulsion periods after a plurality of successive group select periods. It might not be required to apply the repulsion pulses in between every group select period. The undesired movement of the particles through the gate volume may already be suppressed by supplying the repulsion pulses after a series of group select periods. For example only, the repulsion periods may be inserted after every five group select periods. The number of group select periods allowed between two successive repulsion pulses depends on the actual behavior of particles in the pixels. A next repulsion pulse should be applied before the particles start to cross the gate volume. This time period may be determined experimentally, and may be a function of e.g. the temperature of the display. The duration of the repulsion periods should be selected to be sufficiently long to repulse the particles sufficiently far from the gate electrode such that they will not be able to cross the gate volume until a next repulsive pulse is applied. Also this duration can be found experimentally.

In an embodiment as claimed in claim 9, for those pixels in which no particles have to move towards the display electrode, the controller controls the driver to supply the repulsion periods in between two group select periods, and to change the second voltage level to a more repulsive level for the particles prior to the selection of the following group of pixels. Thus, the repulsive level is applied before the next group of pixels is selected. This further decreases the influence of the writing of the next group of pixels on the presently written pixels.

In an embodiment as claimed in claim 10, the controller controls the driver to first change the second voltage differences at an end of the repulsion periods to a level required for a next group select period, and then change the gate voltages to select the next group of pixels. Again, this further decreases the influence of the writing of the next group of pixels on the presently written pixels.

In an embodiment as claimed in claim 11, the controller controls the driver to temporarily change the first voltage difference to a more repulsive level for the particles prior to the selection of the following group of pixels. Thus, the voltage difference between the gate electrode and the reservoir electrode is temporarily changed to repulse the particles from the gate to a higher extent than required during the writing phase for pixels which should not change their optical state.

In an embodiment as claimed in claim 12, the group select periods are line periods during which a line of pixels (usually a row) is selected. The controller controls the driver to supply the first voltage differences and the second voltage differences in parallel to all pixels of the selected line of pixels.

In an embodiment as claimed in claim 13, the controller controls the driver to supply the repulsion periods during the hold period. The extra repulsion pulses prevent the optical state of the pixels to change during the hold period during which no voltage is applied to the electrodes. The absence of the voltages allows the particles to slowly move through the gate volume due to Brownian movement. Consequently, the image slowly becomes vague. By interrupting the hold period during the repulsion period, the particles are repulsed from the gate electrode and thus the original image is kept with a high contrast for a much longer period in time.

In an embodiment as claimed in claim 14, the controller drives the driver to supply repulsion periods overlapping in time for all the pixels. Now, the repulsive pulses occur at least for some time during a same period of time for all the pixels. It is not required to use different voltage differences for different pixels. With different pixels is meant pixels which have different optical state changes. In a two state display, the different optical states are the states wherein no or all particles are in the display volume.

In an embodiment as claimed in claim 15, the controller controls the driver to erase all the pixels during an erase period by gathering the particles at the reservoir electrodes in the reservoir volumes. As usual in displays with pixels having movable charged particles, the image update periods comprise in the following order: the reset period, the write phase, the (optional) evolution phase, and the hold period. In accordance with the present invention, repulsive pulses are added to this drive sequence occurring during an image update period. As described in the foregoing, the repulsive pulses may occur at many instances: in between two successive group (usually row) select periods, after a plurality of successive group select periods, or during the hold period. The repulsive pulses during the write phase may be inserted directly at the end of the select periods.

These and other aspects of the invention are apparent from and will be elucidated with reference to the embodiments described hereinafter.

In the drawings:

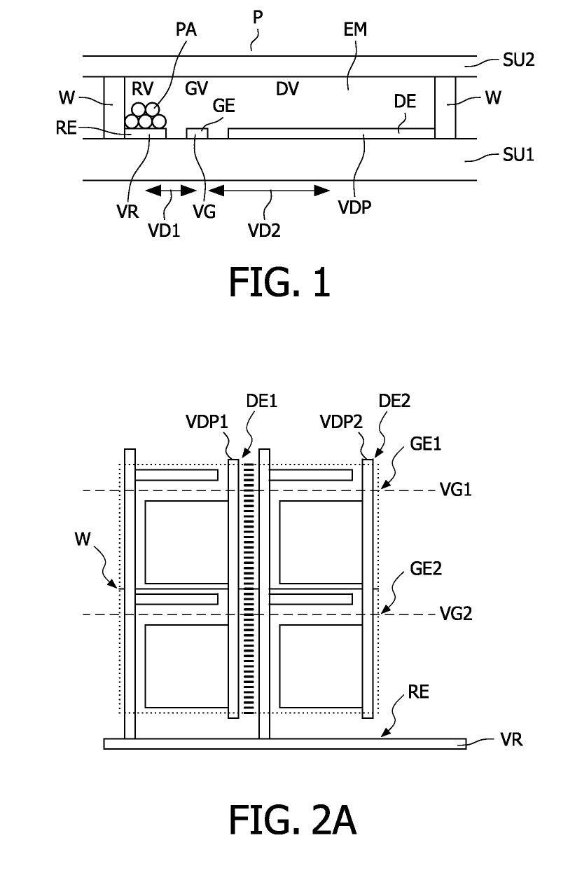

FIG. 1 shows schematically a cross section of a pixel of an in-plane passive electrophoretic display,

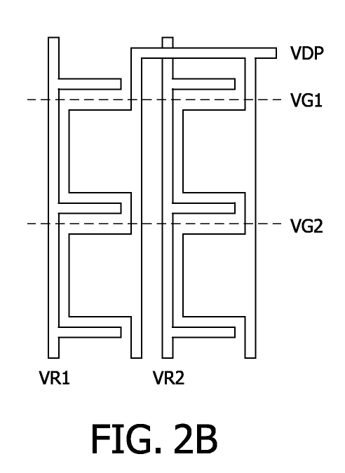

FIGS. 2A and 2B show schematically an electrode arrangement for four pixels of an in-plane electrophoretic passive matrix display,

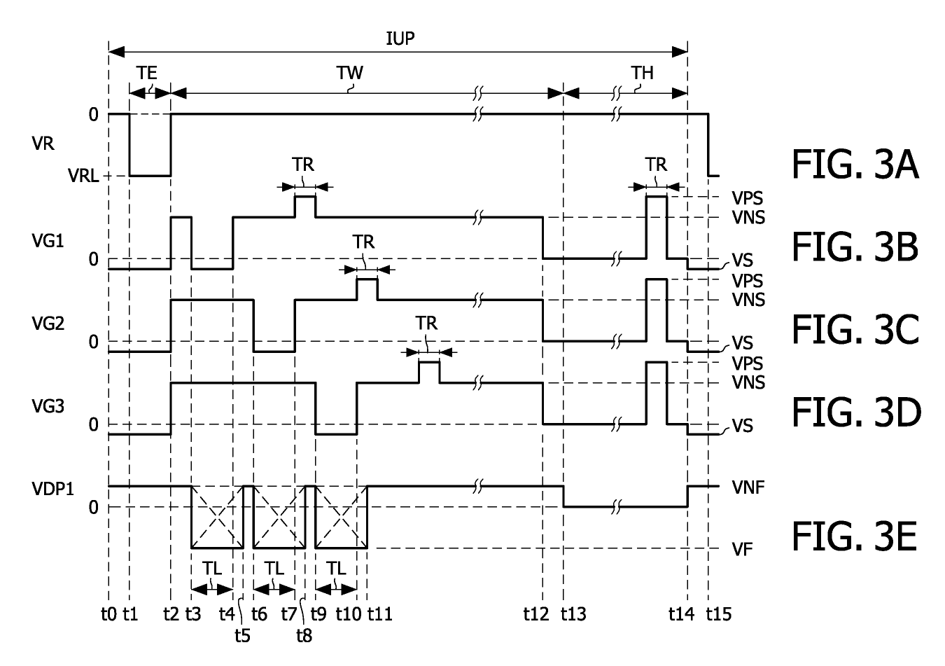

FIGS. 3A to 3E show signals for driving the electrodes of the in-plane electrophoretic display shown in FIG. 2,

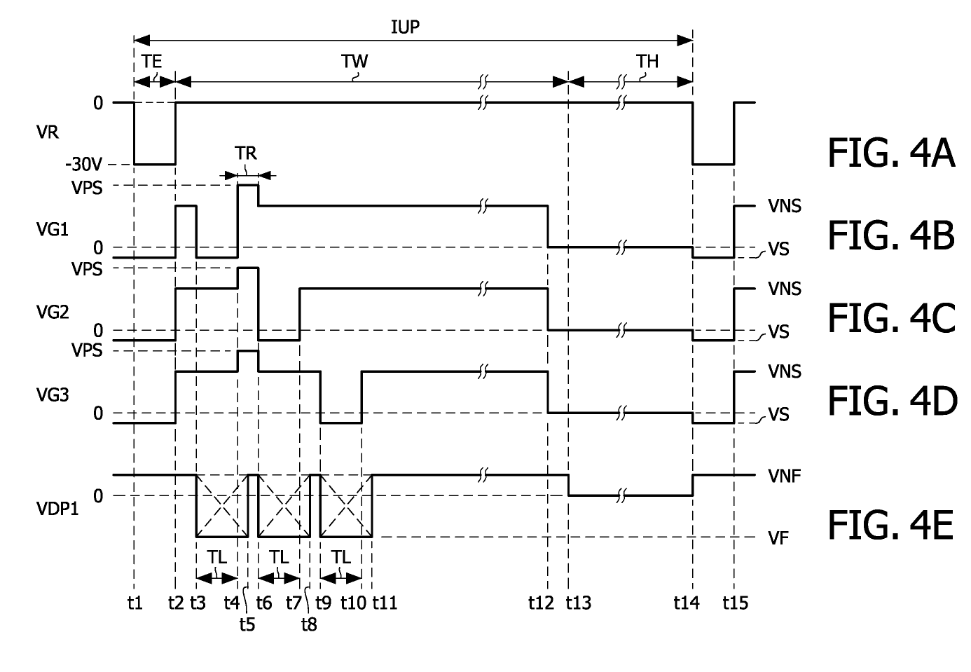

FIGS. 4A to 4E show signals for driving the electrodes of the in-plane electrophoretic display shown in FIG. 2,

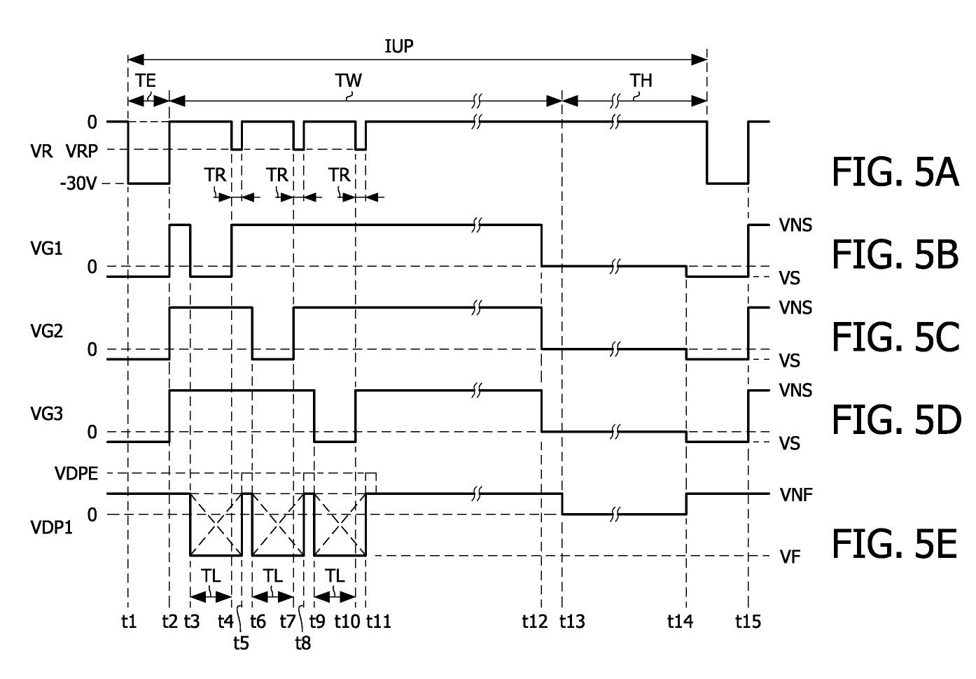

FIGS. 5A to 5E show signals for driving the electrodes of the in-plane electrophoretic display shown in FIG. 2, and

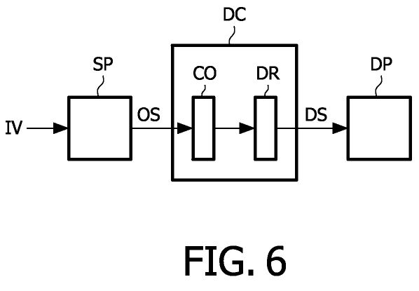

FIG. 6 shows a block diagram of a display apparatus.

It should be noted that items which have the same reference numbers in different Figures, have the same structural features and the same functions, or are the same signals. Where the function and/or structure of such an item has been explained, there is no necessity for repeated explanation thereof in the detailed description.

FIG. 1 shows schematically a cross-section of a pixel of an in-plane electrophoretic passive matrix display. A reservoir electrode RE, a gate electrode GE and a display electrode DE are arranged on top of the substrate SU1. The gate electrode GE is arranged in-between the reservoir electrode RE and the display electrode DE. Alternatively, one or more electrodes could be arranged on the second substrate, providing that they maintain a similar lateral arrangement. The relevant issue is that the particles PA move in the in-plane direction. The reservoir voltage VR is supplied to the reservoir electrode RE, the voltage VG is supplied to the gate electrode GE, and the voltage VDP is supplied to the display electrode DE.

The electrophoretic material EM is sandwiched between the substrates SU1 and SU2. The pixel P is bounded by walls W. The electrophoretic material EM comprises charged particles PA which are moveable in a suspension fluid (either a liquid or a gas) under influence of an electrical field generated by the voltages on the electrodes RE, GE, DE.

In FIG. 1, by way of example, all the particles PA are gathered in the reservoir volume RV above the reservoir electrode RE. The gate volume GV is present above the gate electrode GE and the display volume DV is present above the display electrode DE. The voltage difference VD1 is applied between the gate electrode GE and the reservoir electrode RE. The voltage difference VD2 is applied between the gate electrode GE and the display electrode DE.

FIG. 2A shows schematically an electrode arrangement for four pixels of an in-plane electrophoretic passive matrix display. While FIG. 1 is a side view of the pixel P, FIG. 2 shows a top-view of four of the pixels P. The reservoir electrodes RE, which extend in the column direction and have protrusions in the row direction, may be interconnected to receive a common reservoir voltage VR for all the pixels P. Also the display electrodes DEL and DE2 extend in the column direction and have a square protrusion per pixel P in the row direction. The display electrode DEL receives the display voltage VDP1, and the display electrode DE2 receives the display voltage VDP2. The gate electrodes GE1 and GE2 extend in the row direction in-between the protrusions of the reservoir electrodes RE and the protrusions of the display electrodes DE1, DE2. The gate voltages VG1 and VG2 are supplied to the gate electrodes GE1 and GE2, respectively.

Alternatively, FIG. 2B shows the reservoir electrodes RE, which extend in the column direction and have protrusions in the row direction. Now, the reservoir electrodes are not interconnected and receive the reservoir voltages VR1 and VR2 which are the data voltages VDP1, VDP2 shown in FIG. 2A. The reservoir voltage VR1 is the data voltage VDP1 shown in FIGS. 3, 4 and 5. Thus, now, the reservoir electrodes act as the columns of the display which receive the data voltages VDP1 and VDP2 for the selected row. The display electrodes DE1 and DE2 extend in the column direction and have a square protrusion per pixel P in the row direction. The display electrodes are interconnected and receive a common display voltage VDP for all the pixels P which is the reservoir voltage VR shown in FIGS. 2A, 3, 4 and 5. The gate voltages VG1 and VG2 are supplied to the gate electrodes GE1 and GE2, respectively. Note that the function of the display and reservoir electrodes are interchanged in this case, and the corresponding driving signals are derived straightforwardly from the described cases in FIGS. 3, 4 and 5.

It has to be noted that the arrangement with the common reservoir electrodes RE requires a reset to the display volume DV. However, if the particles are reset to the reservoir volume RV, the repulsive gate pulse is required even for all pixels. A pause (in FIGS. 3A to 3E, the period in time lasting from the instant t4 to the instant t6) is required after a line has been selected to allow particles to return to the reservoir volume RV in case of non-written pixels F. If the data voltages VDP are supplied to the reservoir electrodes RE and a common display electrode is used, this pause is no longer required and select periods TL in subsequent rows can immediately follow one another.

It has to be noted that the pixels P shown in FIGS. 1 and 2 are very specific embodiments only. The orientation of the pixels P may be different, for example, the top and bottom, and/or the row and column directions may be interchanged. The substrate SU2 may not be required. The protrusions of the gate electrodes GE and the display electrodes DE may interleave multiple times in a same pixel P. The walls W may be arranged around a group of pixels P. The shape and size of the pixels P may be different. Further, the pixel may comprise additional electrodes to either assist in distributing particles across the pixel (e.g. in a homogenous manner), or for electrically shielding pixels from neighboring pixels.

Usually, the reservoir volume RV is smaller than the display volume DV. Further, usually the particles PA in the reservoir volume RV are shielded from a viewer, and the optical state of the pixel P is determined by the number of particles PA present in the display volume DV above the display electrode DE. In prior art drive methods of the pixels P shown in FIG. 1, during a reset or erase phase, suitable voltage levels are supplied to the reservoir electrodes RE, the gate electrodes GE and the display electrodes DE such that the charged particles PA are attracted towards the reservoir volume RV where they all gather. Now, all the pixels have the same optical state. The actual voltages supplied to the electrodes RE, GE, DE depend on the type of electrophoretic material used and on the dimensions of the electrodes RE, GE, DE and other elements of the pixel P. During the writing phase the levels of the voltages on the electrodes RE, GE, DE are selected such that all or part of the particles PA are moved from the reservoir volume RV to the display volume DV.

The gate electrodes GE are required in passive matrix displays to introduce a threshold per pixel P. It appeared that the use of gate electrodes GE has some undesirable effects.

Firstly, it was found that an unwanted leakage of particles PA from the reservoir volume RV, across the gate electrode GE through the gate volume GV into the display volume DV occurs for pixels P that during the writing phase should not change their optical state. These pixels P are further also referred to as the non-addressed pixels P. The pixels P which have to change their optical state during the writing phase are referred to as the addressed pixels P. The leakage appeared to be induced if many other pixels P in the same column are being driven to move particles PA into the display volumes DV. Apparently, applying a driving voltage for a prolonged period of time to non-addressed pixels P in the same column eventually causes a reduction of the efficiency of the gate electrode GE and gives rise to a slow leakage of particles PA across the gate electrode GE. It appeared that the leakage often appears at the sides of the pixels P close to the pixel walls and is often associated with the onset of turbulent behavior in the pixel P.

Secondly, an unwanted leakage of the particle PA across the gate electrode GE and a consequent loss of the written image were noticed during the hold phase.

As will be elucidated with respect to the signals shown in FIGS. 3A to 3E, 4A to 4E, and 5A to 5E, the present invention is directed to adding repulsive levels to the usual drive sequence such that the particles PA are repulsed from the gate electrode GE and the unwanted crossing of the particles PA across the gate electrode GE through the gate volume GV is prevented.

By way of example, with respect to all these Figs, it is assumed that the matrix display has pixels P organized in rows and columns. All the reservoir electrodes RE receive the same reservoir voltage VR, and also all the display electrodes DEL, DE2 of the pixels P in the same column receive the same display voltage VDP1, VDP2, respectively. During the writing phase the pixels P are selected row by row by supplying appropriate select voltages VG1, VG2 to the respective rows. Only the pixels P of the selected row change their optical state dependent on the display voltage VDP1, VDP2 supplied to the columns. Further, it is assumed that the particles PA are positively charged. It is easily conceivable how to change the drive sequence of the matrix display if the particles PA are negatively charged or if the gate electrodes GE all receive the same gate voltage VG and the display electrodes DE receive the same display voltages VD per column (but may receive different display voltages VD for different columns).

FIGS. 3A to 3E show signals for driving the electrodes of the in-plane electrophoretic display shown in FIG. 2. FIG. 3A shows the reservoir voltage VR supplied to the reservoir electrode RE. FIG. 3B shows the gate voltage VG1 supplied to the first row of pixels P, FIG. 3C shows the gate voltage VG2 supplied to the second row of pixels P, and FIG. 3D shows the gate voltage VG3 supplied to the third row of pixels P. The gate voltages VG for the other rows of the matrix display are not shown. FIG. 3E shows the display voltage VDP1 supplied to the display electrodes DEL of the first column of pixels P. The display voltages VDP supplied to the other columns of the matrix display are not shown.

First the operation is elucidated for the usual drive of the in-plane electrophoretic matrix display, thus without the repulsion levels, which in FIGS. 3B, 3C, 3D are shown to occur on the gate voltages VG1, VG2, VG3 during the repulsion periods TR. The image update period IUP comprises successively the erase phase TE, the write phase TW, and the hold phase TH.

In a first step, during the erase phase TE which lasts from the instant t1 to the instant t2, for all the pixels P, the particles PA are gathered in the reservoir volume RV. During the erase phase TE, the voltage difference between the reservoir electrode RE and the gate electrode GE is selected to attract the particles PA towards the reservoir electrode RE. Thus, for positively charged particles PA, the reservoir voltage VR should be negative with respect to the gate voltages VG1, VG2, VG3. In the embodiment shown, the reservoir voltage VR has the negative level VRL, which for example is −30V, and the gate voltages VG1, VG2, VG3 have a less negative level VS, which for example is −5V. The voltage difference between the gate electrode GE and the reservoir electrode RE is, in general, also referred to as the gate-reservoir voltage VD1. For a particular gate electrode GE1 the gate-reservoir voltage is indicated by VD1i.

Further, the difference between the gate voltages VG1, VG2, VG3 and the display voltages VDP1, VDP2 should be selected to attract the particles PA towards the gate electrodes GE. Thus, for positively charged particles PA, the display voltages VDP1, VDP2 should be positive with respect to the gate voltages VG1, VG2, VG3. In the example shown, the display voltage VDP1 has the positive level VNF, for example +10V. The voltage difference between the gate electrode GE and the display electrode DE is, in general, also referred to as the gate-display voltage VD2. For a particular gate electrode GE1 the gate-display voltage is indicated by VD2i.

In a second step, during the write phase TW, which lasts from the instant t2 to the instant t13, usually, the rows of pixels P are selected one by one until all the rows have been selected.

A row is not selected if the gate-reservoir voltage VD1 is chosen to keep the particles PA in the reservoir volume RV. In the example shown, the reservoir voltage VR is zero volts and the positively charged particles PA are prevented to move from the reservoir volume RV to the display volume DV by a positive voltage level VNS on the gate electrodes VG1, VG2, VG3. This positive level is also referred to as the non-select level. The level of the display voltage VDP1 is now not relevant because the gate-reservoir voltage VD1 blocks the particles PA from crossing the gate volume GV.

A row is selected if the gate-reservoir voltage VD1 has a level to attract the particles PA from the reservoir volume RV towards the gate volume GV. In the example shown, the particles PA are able to leave the reservoir volume RV if the negative voltage level VS is supplied to the gate electrode GE of the selected row of pixels P. This negative level is also referred to as the select level. Thus, the first row of pixels P is selected during the select period TL lasting from the instant t3 to the instant t4, the second row of pixels P is selected during the select period TL lasting from the instant t6 to the instant t7, and the third row of pixels P is selected during the select period TL lasting from the instant t9 to the instant t10. The other row select periods are not shown. A pixel P of the selected row does not change its optical state if the gate-display voltage VD2 is selected to repulse the particles PA from the display electrode DE. Thus, for positive particles PA, if the display voltage VDP1 is positive with respect to the select level VS of the selected gate electrode VG1, VG2, VG3. In the example shown, this positive non-fill level is indicated by VNF. A pixel P of the selected row changes its optical state if the gate-display voltage VD2 is selected to attract the particles PA towards the display electrode DE. Thus, for positive particles PA, if the display voltage VDP1 is negative with respect to the select level VS of the selected gate electrode VG1, VG2, VG3. In the example shown, this negative fill level is indicated by VF.

In the example shown, the period in time the data is present on the display electrodes DE1, DE2 is somewhat longer than the select periods TL during which the select levels VS of the gate electrodes VG1, VG2, VG3 are present. The data for the first row of pixels P is present during the period in time lasting from the instant t3 to the instant t5, the data for the second row of pixels P is present during the period in time lasting from the instant t6 to the instant t8, and the data for the third row of pixels P is present during the period in time lasting from the instant t9 to the instant t11. This extra time is required to allow the particles PA that have been selected (with the select voltage VS to the gate electrode GE) but not written (the display voltage VDP1 has the level VNF) to return to the reservoir volume RV.

At the end of the write phase TW the image is written into the pixels P and the hold phase TH, which lasts from the instant t13 to t14, starts. Now, all the voltages can be removed from the electrodes and the optical state of the pixels P is kept unaltered. Although not explicitly shown, the hold phase TH may have a relatively long duration with respect to the write phase TW. At the instant t5 the next erase phase TE starts.

Now an embodiment in accordance with the present invention of a drive sequence of the in-plane electrophoretic matrix display is elucidated wherein the repulsion levels on the gate voltage VG1, VG2, VG3 during the repulsion periods TR are added.

The unwanted leakage of particles PA from the reservoir volume RV, across the gate electrode GE through the gate volume GV into the display volume DV for pixels P that during the writing phase should not change their optical state, is prevented by adding repulsive levels during repulsion periods TR occurring during the writing phase TW. The repulsive levels should be selected such that the particles PA are repulsed from the gate electrode GE. This moves any particles PA which tend to cross the gate electrode GE back to the reservoir volume RV and/or display volume DV. Or said differently, during the repulsion periods TR, the gate-reservoir voltage VD1 should have a level which is more repulsive to the particles PA than the gate-reservoir voltage VD1 for non selected pixels P, and/or the gate-display voltage VD2 should have a level which is more repulsive to the particles PA than the gate-display voltage VD2 for non selected pixels P. These more repulsive levels occur during the write phase in between successive group select periods TL.

In the example shown, during the repulsion periods TR pulses are superimposed on the select voltage VG1, VG2, VG3 after the select period TL which succeeds the select period TL of the select voltage VG1, VG2, VG3. For the select voltage VG1, the select period TL occurs from the instant t3 to the instant t4, and the extra repulsive level occurs from the instant t7 to t9 thus after the select period TL which lasts from t6 to t7. For the select voltage VG2, the select period TL occurs from the instant t6 to the instant t7, and the extra repulsive level starts at the instant t10 thus after the select period TL which lasts from t9 to t10, and so on. It has to be noted that this is an embodiment only, many alternatives are possible. For example, the extra repulsive levels may occur with a fixed time offset with respect to the select period TL of the particular select voltage VG1, VG2, VG3, which lasts a plurality of select periods TL. Several extra repulsive levels may occur during the write phase TW on each of the gate voltages VG1, VG2, VG3. Preferably, for each of the gate voltages VG1, VG2, VG3, the plurality of repulsive levels are evenly distributed in time.

The repulsive levels may only be inserted for pixels P which should not change their optical state. Preferably, these repulsive levels are inserted before the select period TL wherein the pixels P are selected.

Further, unwanted particle PA leakage across the gate electrode GE and a consequent loss of the written image is prevented by adding extra repulsive levels during repulsion periods TR during the hold phase TH. The extra repulsive levels may be added during the write phase TW and/or hold phase TH.

FIGS. 4A to 4E show signals for driving the electrodes of the in-plane electrophoretic display shown in FIG. 2. FIG. 4A shows the reservoir voltage VR supplied to the reservoir electrode RE. FIG. 4B shows the gate voltage VG1 supplied to the first row of pixels P, FIG. 4C shows the gate voltage VG2 supplied to the second row of pixels P, and FIG. 4D shows the gate voltage VG3 supplied to the third row of pixels P. The gate voltages VG for the other rows of the matrix display are not shown. FIG. 4E shows the display voltage VD1 supplied to the display electrodes DE1 of the first column of pixels P. The display voltages VD supplied to the other columns of the matrix display are not shown.

These FIGS. 4A to 4E only slightly differ from the FIGS. 3A to 3E, therefore, only these differences are discussed. Now, the repulsion periods TR with the extra repulsive levels VPS occur in between two successive select periods TL on all gate voltages VG1, VG2, VG3. The repulsion periods TR may be added in between all select periods TL, or once every predetermined number of select periods TL. Optionally, also extra repulsive levels may be present during the hold period TH.

FIGS. 5A to 5E show signals for driving the electrodes of the in-plane electrophoretic display shown in FIG. 2. FIG. 5A shows the reservoir voltage VR supplied to the reservoir electrode RE. FIG. 5B shows the gate voltage VG1 supplied to the first row of pixels P, FIG. 5C shows the gate voltage VG2 supplied to the second row of pixels P, and FIG. 5D shows the gate voltage VG3 supplied to the third row of pixels P. The gate voltages VG for the other rows of the matrix display are not shown. FIG. 5E shows the display voltage VDP1 supplied to the display electrodes DEL of the first column of pixels P. The display voltages VDP supplied to the other columns of the matrix display are not shown.

These FIGS. 5A to 5E only slightly differ from the FIGS. 3A to 3E, therefore, only these differences are discussed. Now, during the repulsion periods TR, repulsive levels are not added to the gate voltages VG1, VG2, VG3, but to both the reservoir voltage VR and the display voltage VDP1. For positive particles PA, during the repulsion periods TR, the reservoir voltage VR gets a negative level VRP, and the display voltage VDP1 gets a positive level VDPE which is higher than the non-fill level VNF. In the example shown, the repulsion periods TR occur in between all select periods TL. Alternatively, the repulsion periods TR may occur during the periods in time show and discussed with respect to FIGS. 3A to 3E and FIGS. 4A to 4E.

FIG. 6 shows a block diagram of a display apparatus. A signal processing circuit SP receives an input signal IV, which represents an image to be displayed on the in-plane driven electrophoretic device DP, to supply the output signal OS to the drive circuit DC. The drive circuit DC comprises a controller CO and a driver DR. The controller CO receives the output signal OS of the signal processing circuit SP and controls the driver DR to supply the drive signals DS to the in-plane electrophoretic device DP.

It should be noted that the above-mentioned embodiments illustrate rather than limit the invention, and that those skilled in the art will be able to design many alternative embodiments without departing from the scope of the appended claims.

For example, although most embodiments in accordance with the invention are described with respect to a particular electrophoretic display, the invention is also suitable for electrophoretic displays in general and for bi-stable electrophoretic displays. A bi-stable display is defined as a display wherein the pixels substantially maintain their grey level/brightness after the power/voltage to the pixel has been removed. If the particles have other colors than white and black, still, the intermediate states may be referred to as grey scales. Alternatively the device can be a moving particle device, for example a micro-fluidic device containing charged biological particles (DNA or proteins, which are not at their iso-electrical point). In the case of a micro-fluidic device, the concept of a “pixel” should be substituted by a capsule containing e.g. the sample fluid, whilst the nomenclature of electrodes should be changed from a “display” electrode to an electrode associated with a sensor area or a processing area in the micro-fluidic device.

Bi-stable display panels can form the basis of a variety of applications where information may be displayed, for example in the form of information signs, public transport signs, advertising posters, pricing labels, billboards etc. In addition, they may be used where a changing non-information surface is required, such as wallpaper with a changing pattern or color, especially if the surface requires a paper like appearance.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driving circuit for driving an in-plane moving particle device having a pixel (P) comprising movable charged particles (PA), a reservoir electrode (RE), a display electrode (DE), and a gate electrode (GE) laterally spaced in-between the reservoir electrode (RE) and the display electrode (DE), the driving circuit (DC) comprises:
a driver (DR),
a controller (CO) for receiving an input signal (OS) representing an image to be displayed on the moving particle device to control the driver (DR) for supplying a first voltage difference (VD1) between the reservoir electrode (RE) and the gate electrode (GE), and a second voltage difference (VD2) between the gate electrode (GE) and the display electrode (DE):
(i) during a write phase (TW) to obtain an optical state of the pixel (P) in conformity with the image by moving at least part of the particles (PA) from the reservoir electrode (RE) via the gate electrode (GE) to the display electrode (DE) if the optical state of the pixel (P) should change, or wherein said first voltage difference (VD1) has a first write level being selected to repulse the particles (PA) from the gate electrode (GE) and said second voltage difference (VD2) has a second write level being selected to repulse the particles (PA) from the gate electrode (GE) if the optical state of the pixel (P) should not change, and
(ii) during a repulsion period (TR), to supply the first voltage difference (VD1) having a level being more repulsive to the particles than the first write level, and/or the second voltage difference (VD2) being more repulsive than the second write level.

2. A driving circuit as claimed in claim 1, wherein the moving particle device is a passive matrix display (DP) having a plurality of the pixels (P), the controller (CO) being constructed for controlling the driver (DR) to supply first voltage differences (VD1) between associated gate electrodes (GE) and reservoir electrodes (RE) of the pixels (P), and second voltage differences (VD2) between associated gate electrodes (GE) and display electrodes (DE) of the pixels (P).

3. A driving circuit as claimed in claim 1, wherein the reservoir electrode (RE), the gate electrode (GE), and the display electrode (DE) are arranged on a same substrate.

4. A driving circuit as claimed in claim 1, wherein the controller (CO) is constructed for maintaining the written image during a hold period (TH).

5. A driving circuit as claimed in claim 2, wherein the controller (CO) is constructed for obtaining the repulsion period (TR) during the write phase (TW).

6. A driving circuit as claimed in claim 5 when dependent on claim 2, wherein the driver (DR) is constructed for sequentially selecting the pixels (P) during the write phase (TW) group by group, each group during a group select period (TL), until all pixels P have been selected, the first voltage differences (VD1) and the second voltage differences (VD2) being supplied to all the pixels (P) of a selected one of the groups during the group select period (TL).

7. A driving circuit as claimed in claim 6, wherein the controller (CO) is constructed for obtaining the repulsion periods (TR) in between two successive group select periods (TL).

8. A driving circuit as claimed in claim 6, wherein the controller (CO) is constructed for obtaining the repulsion periods (TR) after a plurality of successive group select periods (TL).

9. A driving circuit as claimed in claim 6, wherein, for those pixels (P) in which no particles (PA) have to move towards the display electrode (DE), the controller (CO) is constructed for obtaining the repulsion periods (TR) in between two group select periods (TL), and for controlling the driver (DR) to change the second voltage difference (VD2) to a more repulsive level for the particles (PA) prior to the selection of the following group of pixels.

10. A driving circuit as claimed in claim 7, wherein the controller (CO) is constructed for controlling the driver (DR) to first change the second voltage difference (VD2) at an end of the repulsion periods (TR) to a level required for a next group select period (TL), and then change the gate voltages (VG) to select the next group of pixels (P).

11. A driving circuit as claimed in claim 7, wherein the controller (CO) is constructed for controlling the driver (DR) to temporarily change the first voltage difference (VD1) to a more repulsive level for the particles (PA) prior to the selection of the following group of pixels (P).

12. A driving circuit as claimed in claim 6, wherein the group select periods (TL) are line periods during which a line of pixels (P) is selected, the controller (CO) being constructed for controlling the driver (DR) to supply the first voltage differences (VD1) and the second voltage differences (VD2) in parallel to all pixels (P) of the selected line of pixels (P).

13. A driving circuit as claimed in claim 4, wherein the controller (CO) is constructed for controlling the driver (DR) to supply the repulsion period (TR) during the hold period (TH).

14. A driving circuit as claimed in claim 5, wherein the controller (CO) is constructed for driving the driver (DR) to supply the repulsion periods (TR) overlapping in time for all the pixels (P).

15. A driving circuit as claimed in claim 5, wherein the controller (CO) is constructed for controlling the driver (DR) to reset all the pixels (P) during a reset period (TR) to gather the particles (PA) at the reservoir electrodes (RE), and for creating image update periods (IUP) comprising in the following order: the reset period (TR), the write phase (TW), the hold period (TH).

16. (canceled)

17. (canceled)

18. (canceled)

19. A method of driving an in-plane moving particle device (DP) having a pixel (P) comprising movable charged particles (PA), a reservoir electrode (RE), a display electrode (DE), and a gate electrode (GE) laterally space in-between the reservoir electrode (RE) and the display electrode (DE), the method (DC) comprises:
receiving (CO) an input signal (OS) representing an image to be displayed on the moving particle device for supplying a first voltage difference (VD1) between the reservoir electrode (RE) and the gate electrode (GE), and a second voltage difference (VD2) between the gate electrode (GE) and the display electrode (DE):
(i) during a write phase (TW) to obtain an optical state of the pixel (P) in conformity with the image by moving at least part of the particles (PA) from the reservoir electrode (RE) via the gate electrode (GE) to the display electrode (DE) if the optical state of the pixel (P) should change, or wherein said first voltage difference (VD1) has a first write level being selected to repulse the particles (PA) from the gate electrode (GE) and said second voltage difference (VD2) has a second write level being selected to repulse the particles (PA) from the gate electrode (GE) if the optical state of the pixel (P) should not change, and
(ii) during a repulsion period (TR), to supply the first voltage difference (VD1) having a level being more repulsive to the particles than the first write level, and/or the second voltage difference (VD2) being more repulsive than the second write level.
